(19) United States
(12) Patent Application Publication
(10) Pub. No.: US 2022/0196406 A1
(43) Pub. Date: Jun. 23, 2022

(54) METHOD AND APPARATUS FOR DEFINING A NAVIGABLE AREA OF AN INDOOR SPACE USING LOCATION TRACE SNIPPETS

(71) Applicant: HERE Global B.V., Eindhoven (NL)

(72) Inventors: Lauri Aarne Johannes WIROLA, Tampere (FI); Petri RAUHALA, Tampere (FI); Asit VACHHANI, Berlin (DE); Siddharth KHASGIWALA, Berlin (DE); Maarit ASIKAINEN, Berlin (DE)

(73) Assignee: HERE Global B.V., Eindhoven (NL)

(21) Appl. No.: 17/132,843

(22) Filed: Dec. 23, 2020

(51) Int. Cl. G01C 21/20; H04W 4/02; H04W 4/029; H04W 4/33

(52) U.S. Cl. CPC G01C 21/206; H04W 4/33; H04W 4/029; H04W 4/023

(57) ABSTRACT

A method, apparatus and computer program product are provided to generate or modify information about a navigable area of an indoor space. In the context of a method, location data is received or determined for a plurality of location trace snippets associated with one or more mobile devices. Each location trace snippet of the plurality of location trace snippets respectively represents a plurality of respective locations of a respective mobile device within the indoor space over a respective limited period of time. The respective limited period of time associated with a location trace snippet may be defined based upon satisfaction of a trigger condition. Based on the location data for the plurality of location trace snippets, the method also generates or modifies information about one or more navigable areas of the indoor space.

### TECHNOLOGICAL FIELD

An example embodiment relates generally to a method, apparatus and computer program product for defining one or more navigable areas of an indoor space and, more particularly, to defining one or more navigable areas of an indoor space based upon location trace snippets that are each respectively formed of location data collected by a mobile device over a limited period of time.

### BACKGROUND

Maps of indoor spaces are utilized for a wide variety of purposes. For example, maps of indoor spaces, such as the floors of a building, the layout of a warehouse or other storage facility, etc., may be utilized for navigational purposes. In this regard, the maps of indoor spaces may provide the basis for navigational instructions directing a user from a current location to a destination within the indoor space.

Maps of indoor spaces may be created in various manners. For example, maps may be created based upon manual or computer-aided drawings of the indoor space. However, these drawings may be incomplete or otherwise contain insufficient information such that the resulting maps of the indoor spaces are correspondingly incomplete. Additionally, or alternatively, maps of indoor spaces may be based upon probe points collected by the mobile devices carried by one or more users as the user(s) move about the indoor space. However, probe points that are collected may similarly be incomplete in that probe points may be collected for certain portions of the indoor space, but not other portions of the indoor space depending upon the frequency with which the users move throughout the different portions of the indoor space.

Even if a map of an indoor space is created that is both complete and accurate, indoor spaces may be reconfigured over the course of time. For example, walls may be moved, cubicles may be repositioned, furniture may be added or discarded, etc. In these instances, even if the map that was previously created for the space was both accurate and complete, the map may be inaccurate once modifications have been made to the indoor space.

In an instance in which a map of an indoor space is inaccurate or incomplete, either as initially constructed or following modification of the indoor space, the resulting user experience may be unsatisfactory. In this regard, a user might be provided with navigational instructions that are nonsensical or that direct the user to proceed along a route that is not the most efficient, thereby leading the user to have less confidence in the maps of the indoor space and the applications that rely upon the maps of the indoor space.

### BRIEF SUMMARY

A method, apparatus and computer program product of an example embodiment are configured to generate or modify information about a navigable area of an indoor space. As such, a map of the indoor space may be created or updated that is more accurate and complete, thereby leading to an improved user experience in relation to applications that rely upon the map of the indoor space. The method, apparatus and computer program product of an example embodiment are configured to generate or modify information about a navigable area of an indoor space based on one or more location trace snippets indicative of movement of a mobile device over a limited period of time. The location trace snippets provide the requisite information regarding a navigable area of an indoor space, but does so in a manner that increases the privacy associated with the user of the mobile device that serves to collect the location data from which the location trace snippet is constructed, while also conserving power, bandwidth and processing resources associated with the collection and processing of information regarding a navigable area of an indoor space.

In an example embodiment, a method is provided for generating or modifying information about one or more navigable areas of an indoor space. The method includes receiving or determining, by processing circuitry, location data for a plurality of location trace snippets associated with one or more mobile devices. Each location trace snippet of the plurality of location trace snippets respectively represents a plurality of respective locations of a respective mobile device within the indoor space over a respective limited period of time. The respective limited period of time associated with a location trace snippet may be defined based upon satisfaction of a trigger condition. Based on the location data for the plurality of location trace snippets, the method also generates or modifies, by the processing circuitry, information about one or more navigable areas of the indoor space.

The plurality of location trace snippets of an example embodiment include two or more location trace snippets associated with the respective mobile device within the indoor space. Each location trace snippet that is associated with the respective mobile device represents the plurality of respective locations of the respective mobile device over a different limited period of time. Additionally or alternatively, the plurality of location trace snippets may include one or more location trace snippets associated with a first mobile device of the one or more mobile devices within the indoor space and one or more location trace snippets associated with a second mobile device of the one or more mobile devices within the indoor space.

The method of an example embodiment generates or modifies information about one or more navigable areas of the indoor space by determining a location of an object within the indoor space based upon the location trace snippet. In another example embodiment, the method generates or modifies information about one or more navigable areas of the indoor space by determining a path through or area within the indoor space based upon the location trace snippet. The method of a further example embodiment generates or modifies information about one or more navigable areas of the indoor space by determining a direction of travel through at least a portion of the indoor space based upon the location trace snippet. In yet another example embodiment, the method generates or modifies information about one or more navigable areas of the indoor space by determining a boundary or shape of the indoor space based upon the location trace snippet.

In another example embodiment, an apparatus is provided that is configured to generate or modify information about one or more navigable areas of an indoor space. The apparatus includes processing circuitry and at least one memory including computer program code instructions with the computer program code instructions configured to, when executed by the processing circuity, cause the apparatus to receive or determine location data for a plurality of location trace snippets associated with one or more mobile devices. Each location trace snippet of the plurality of location trace snippets respectively represents a plurality of respective locations of a respective mobile device within the indoor space over a respective limited period of time. The respective limited period of time associated with a location trace snippet may be defined based upon satisfaction of a trigger condition. The computer program code instructions are also configured to, when executed by the processing circuity, cause the apparatus to generate or modify information about one or more navigable areas of the indoor space based on the location data for the plurality of location trace snippets.

The computer program code instructions of an example embodiment that are configured to generate or modify information about one or more navigable areas of the indoor space include computer program code instructions configured to determine a location of an object within the indoor space based upon the location trace snippet. In another example embodiment, the computer program code instructions configured to generate or modify information about one or more navigable areas of the indoor space include computer program code instructions configured to determine a path through or area within the indoor space based upon the location trace snippet. The computer program code instructions configured to generate or modify information about one or more navigable areas of the indoor space in accordance with a further example embodiment include computer program code instructions configured to determine a direction of travel through at least a portion of the indoor space based upon the location trace snippet. In yet another example embodiment, the computer program code instructions configured to generate or modify information about one or more navigable areas of the indoor space include computer program code instructions configured to determine a boundary or shape of the indoor space based upon the location trace snippet.

In a further example embodiment, a computer program product is provided that is configured to generate or modify information about one or more navigable areas of an indoor space. The computer program product includes a non-transitory computer readable medium having program code stored thereon with the program code including program code instructions configured, upon execution, to receive or determine location data for a plurality of location trace snippets associated with one or more mobile devices. Each location trace snippet of the plurality of location trace snippets respectively represents a plurality of respective locations of a respective mobile device within the indoor space over a respective limited period of time. The respective limited period of time associated with a location trace snippet may be defined based upon satisfaction of a trigger condition. The program code further includes program code instructions configured to generate or modify information about one or more navigable areas of the indoor space based on the location data for the plurality of location trace snippets.

The program code instructions of an example embodiment that are configured to generate or modify information about one or more navigable areas of the indoor space include program code instructions configured to determine a location of an object within the indoor space based upon the location trace snippet. In another example embodiment, the program code instructions configured to generate or modify information about one or more navigable areas of the indoor space include program code instructions configured to determine a path through or area within the indoor space based upon the location trace snippet. The program code instructions configured to generate or modify information about one or more navigable areas of the indoor space in accordance with a further example embodiment include program code instructions configured to determine a direction of travel through at least a portion of the indoor space based upon the location trace snippet. In yet another example embodiment, the program code instructions configured to generate or modify information about one or more navigable areas of the indoor space include program code instructions configured to determine a boundary or shape of the indoor space based upon the location trace snippet.

In yet another example embodiment, an apparatus is provided for generating or modifying information about one or more navigable areas of an indoor space. The apparatus includes means for receiving or determining location data for a plurality of location trace snippets associated with one or more mobile devices. Each location trace snippet of the plurality of location trace snippets respectively represents a plurality of respective locations of a respective mobile device within the indoor space over a respective limited period of time. The respective limited period of time associated with a location trace snippet may be defined based upon satisfaction of a trigger condition. The apparatus also includes means for generating or modifying information about one or more navigable areas of the indoor space based on the location data for the plurality of location trace snippets.

The means for generating or modifying information about one or more navigable areas of the indoor space in one example embodiment includes means for determining a location of an object within the indoor space based upon the location trace snippet. In another example embodiment, the means for generating or modifying information about one or more navigable areas of the indoor space includes means for determining a path through or area within the indoor space based upon the location trace snippet. The means for generating or modifying information about one or more navigable areas of the indoor space in accordance with a further example embodiment includes means for determining a direction of travel through at least a portion of the indoor space based upon the location trace snippet. In yet another example embodiment, the means for generating or modifying information about one or more navigable areas of the indoor space includes means for determining a boundary or shape of the indoor space based upon the location trace snippet.

In an example embodiment, a method is disclosed for providing location data for a location trace snippet associated with a mobile device. The method includes collecting at least the location data for the location trace snippet. The location trace snippet represents one or more respective locations of the mobile device within an indoor space over a respective limited period of time. The method also includes determining, by processing circuitry, that a trigger condition has been satisfied. In response to determining that the trigger condition has been satisfied, the method further includes causing the location data for the location trace snippet to be provided to one or more servers, thereby enabling the one or more servers to generate or modify information about one or more navigable areas of the indoor space.

The method of an example embodiment collects the location data by commencing collection of the location data for the limited period of time in response to determining that the trigger condition has been satisfied. In an alternative embodiment, the method collects the location data by collecting the location data without regard to the satisfaction of the trigger condition. In this example embodiment, the method further includes determining the location data for the location trace snippet from among the location data that has been collected based upon the satisfaction of the trigger condition.

The limited period of time may be based upon a time at which the trigger condition was satisfied. In an example embodiment, determining that the trigger condition has been satisfied includes or is based on one or more of: (i) identification of a predefined pattern of movement of the mobile device through the indoor space, (ii) identification that the mobile device has entered a room or moved between rooms, (iii) identification of a change in characteristics of radio signals received by the mobile device, (iv) a predefined schedule or (v) a request from the one or more servers. The predefined pattern of movement may include a turn. In an example embodiment, determining that the trigger condition has been satisfied includes or is based on identifying entry of the mobile device into a predefined operational state.

In another example embodiment, an apparatus is disclosed that is configured to provide location data for a location trace snippet associated with a mobile device. The apparatus includes processing circuitry and at least one memory including computer program code instructions with the computer program code instructions configured to, when executed by the processing circuity, cause the apparatus to collect at least the location data for the location trace snippet. The location trace snippet represents one or more respective locations of the mobile device within an indoor space over a respective limited period of time. The computer program code instructions are also configured to, when executed by the processing circuity, cause the apparatus to determine that a trigger condition has been satisfied. In response to determining that the trigger condition has been satisfied, the computer program code instructions are further configured to, when executed by the processing circuity, cause the apparatus to cause the location data for the location trace snippet to be provided to one or more servers, thereby enabling the one or more servers to generate or modify information about one or more navigable areas of the indoor space.

The computer program code instructions configured to collect the location data include, in an example embodiment, computer program code instructions configured to commence collection of the location data for the limited period of time in response to determining that the trigger condition has been satisfied. In an alternative embodiment, the computer program code instructions configured to collect the location data include computer program code instructions configured to collect the location data without regard to the satisfaction of the trigger condition. In this example embodiment, the apparatus further includes computer program code instructions configured to determine the location data for the location trace snippet from among the location data that has been collected based upon the satisfaction of the trigger condition.

The limited period of time may be based upon a time at which the trigger condition was satisfied. In an example embodiment, determining that the trigger condition has been satisfied includes or is based on one or more of: (i) identification of a predefined pattern of movement of the mobile device through the indoor space, (ii) identification that the mobile device has entered a room or moved between rooms, (iii) identification of a change in characteristics of radio signals received by the mobile device, (iv) a predefined schedule or (v) a request from the one or more servers. The predefined pattern of movement may include a turn. In an example embodiment, determining that the trigger condition has been satisfied includes or is based on identifying entry of the mobile device into a predefined operational state.

In a further example embodiment, a computer program product is disclosed that is configured to provide location data for a location trace snippet associated with a mobile device. The computer program product includes a non-transitory computer readable medium having program code stored thereon with the program code including program code instructions configured, upon execution, to collect at least the location data for the location trace snippet. The location trace snippet represents one or more respective locations of the mobile device within an indoor space over a respective limited period of time. The program code also includes program code instructions configured to determine that a trigger condition has been satisfied. In response to determining that the trigger condition has been satisfied, the program code further includes program code instructions configured to cause the location data for the location trace snippet to be provided to one or more servers, thereby enabling the one or more servers to generate or modify information about one or more navigable areas of the indoor space.

The program code instructions of an example embodiment that are configured to collect the location data include program code instructions configured to commence collection of the location data for the limited period of time in response to determining that the trigger condition has been satisfied. In an alternative embodiment, the program code instructions configured to collect the location data include program code instructions configured to collect the location data without regard to the satisfaction of the trigger condition. In this example embodiment, the program code further includes program code instructions configured to determine the location data for the location trace snippet from among the location data that has been collected based upon the satisfaction of the trigger condition.

The limited period of time may be based upon a time at which the trigger condition was satisfied. In an example embodiment, determining that the trigger condition has been satisfied includes or is based on one or more of: (i) identification of a predefined pattern of movement of the mobile device through the indoor space, (ii) identification that the mobile device has entered a room or moved between rooms, (iii) identification of a change in characteristics of radio signals received by the mobile device, (iv) a predefined schedule or (v) a request from the one or more servers. The predefined pattern of movement may include a turn. In an example embodiment, determining that the trigger condition has been satisfied includes or is based on identifying entry of the mobile device into a predefined operational state.

In yet another example embodiment, an apparatus is disclosed that is configured to provide location data for a location trace snippet associated with a mobile device. The apparatus includes means for collecting at least the location data for the location trace snippet. The location trace snippet represents one or more respective locations of the mobile device within an indoor space over a respective limited period of time. The apparatus also includes means for determining that a trigger condition has been satisfied. In response to determining that the trigger condition has been satisfied, the apparatus further includes means for causing the location data for the location trace snippet to be provided to one or more servers, thereby enabling the one or more servers to generate or modify information about one or more navigable areas of the indoor space.

The means for collecting the location data in accordance with an example embodiment includes means for commencing collection of the location data for the limited period of time in response to determining that the trigger condition has been satisfied. In an alternative embodiment, the means for collecting the location data includes means for collecting the location data without regard to the satisfaction of the trigger condition. In this example embodiment, the apparatus further includes means for determining the location data for the location trace snippet from among the location data that has been collected based upon the satisfaction of the trigger condition.

The limited period of time may be based upon a time at which the trigger condition was satisfied. In an example embodiment, determining that the trigger condition has been satisfied includes or is based on one or more of: (i) identification of a predefined pattern of movement of the mobile device through the indoor space, (ii) identification that the mobile device has entered a room or moved between rooms, (iii) identification of a change in characteristics of radio signals received by the mobile device, (iv) a predefined schedule or (v) a request from the one or more servers. The predefined pattern of movement may include a turn. In an example embodiment, determining that the trigger condition has been satisfied includes or is based on identifying entry of the mobile device into a predefined operational state.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates an indoor space and a plurality of mobile devices moving through the indoor space and in communication with a server in accordance with an example embodiment of the present disclosure;

FIG. 2 is a block diagram of an apparatus specifically configured in accordance with an example embodiment of the present disclosure;

FIG. 3 is a flowchart illustrating the operations performed, such as by the apparatus of FIG. 2 as embodied by a mobile device, in accordance with an example embodiment of the present disclosure;

FIG. 4 illustrates a portion of an indoor space in which the navigable area defines a turn;

FIG. 5 is a flowchart illustrating the operations performed, such as by the apparatus of FIG. 2 as embodied by a server, in accordance with an example embodiment of the present disclosure; and

FIG. 6 illustrates a portion of an indoor space in which the navigable area defines two paths of travel about obstacle with the two paths of travel proceeding in opposite directions.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment in order to provide location data for a location trace snippet associated with a mobile device. The location trace snippets define the manner in which a mobile device and, as a result, the user of the mobile device moves through a navigable area within a portion of an indoor space. Additionally, a method, apparatus and computer program product are provided in accordance with another example embodiment in order to generate or modify information about one or more navigable areas of an indoor space based upon one or more location trace snippets representative of location data that has been collected over a limited amount of time by a respective mobile device during movement through a navigable area within the indoor space. Based on the information that is generated or modified about a navigable area of the indoor space, a map of the indoor space may be created or updated and may thereafter be used by one or more applications, such as a mapping or navigation application or a social media application.

By being created or updated based on information derived from one or more location trace snippets, reliance on the map of the indoor space provides an enhanced user experience as a result of the increased accuracy of the information provided to the respective application. Additionally, by basing the information regarding one or more navigable areas of an indoor space upon location trace snippets comprised of location data collected by a mobile device over a limited period of time, a number of additional technical advantages are provided by the method, apparatus and computer program product of an example embodiment. In this regard, the privacy of the mobile device and, in turn, the user of the mobile device is enhanced by relying upon location trace snippets that are limited to respective periods of time, as opposed to relying upon location data that is collected over a more continuous basis. Additionally, the reliance upon location trace snippets that are associated with and limited to a period of time in order to provide information regarding one or more navigable areas of an indoor space may allow for power, bandwidth and processing resources to be conserved relative to the power, bandwidth and processing resources otherwise consumed by the collection, provision and processing of location data that has been collected on a relatively continuous basis.

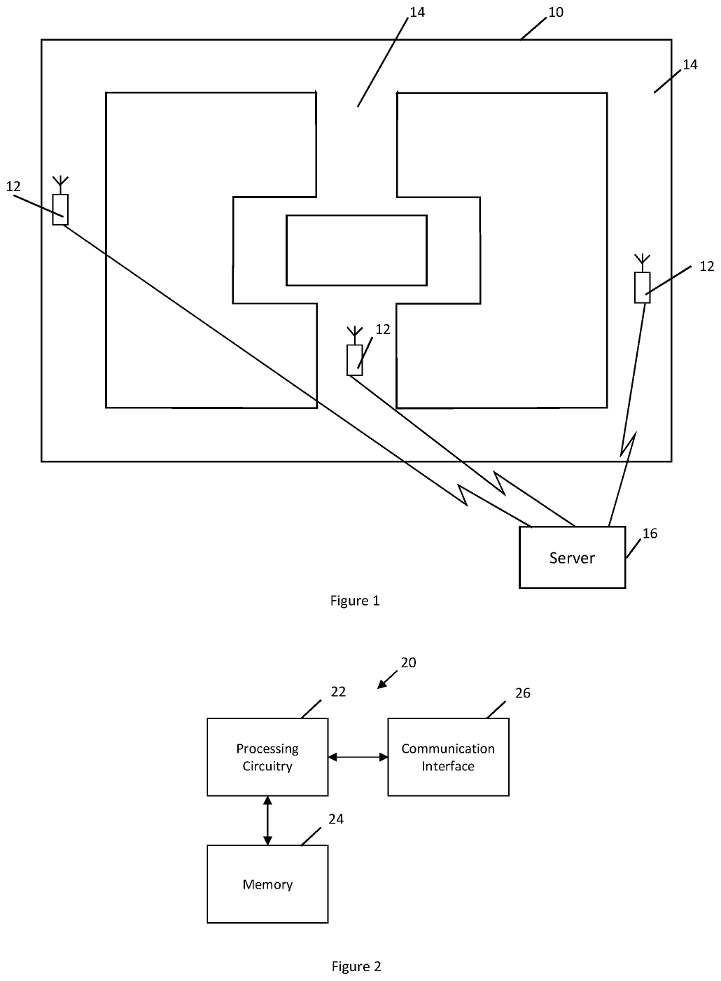

Referring now to FIG. 1, an example of a portion of an indoor space 10 in which location trace snippets are collected, such as for subsequent use in relation to defining a navigable area within the indoor space. Although the indoor space of FIG. 1 is a portion of a floor of an office building, location trace snippets may be collected for any wide variety of indoor spaces including hospitals and school complexes, warehouses and storage facilities, shopping centers or malls, etc. As shown in FIG. 1, one or more mobile devices 12 move throughout one or more navigable areas of the indoor space, that is, one or more areas through which a user carrying a mobile device is able to walk or otherwise move. Examples of navigable areas include hallways 14, reception areas, conference rooms, offices, stairwells, etc. As shown in FIG. 1, three different mobile devices move throughout the navigable areas of the portion of the indoor space that is depicted. Each mobile device may be carried by a different user, and, as such, may be moving throughout different portions, such as through different navigable areas, of the indoor space. The mobile devices that are carried by a user and that move throughout a navigable area of an indoor space may be any of a variety of mobile devices including, for example, a mobile terminal including, for example, a personal digital assistant (PDA), mobile telephone, smart phone, personal navigation device, smart watch, tablet computer, or any combination of the aforementioned and other types of portable computer devices.

In the illustrated embodiment, the mobile devices 12 are configured to be in communication with a server 16 or other network entity (hereinafter generically referenced as a server for proposes of explanation, but not of limitation). The mobile devices and the server may be configured to communicate in any of a variety of different manners including, for example, via cellular communications or other types of wireless communications including, but not limited to, Wi-Fi, Bluetooth, ultra-wide band (UWB), a wireless local area network (WLAN) or the like.

The mobile devices 12 are configured to collect location data in the form of location trace snippets, each of which is collected over a limited period of time. The location trace snippets are provided by the mobile devices to the server 16. The server, in turn, processes the information provided by the location trace snippets regarding one or more navigable areas within the indoor space. Based upon this information, the server may be configured to create or update maps of the indoor space.

In accordance with an example embodiment, an apparatus is provided that may be embodied by any of a variety of computing devices including a mobile device 12 in accordance with one example embodiment or a server 16 in accordance with another example embodiment. Regardless of the type of computing device that embodies the apparatus, the apparatus 20 includes or is associated with or is otherwise in communication with processing circuitry 22, a memory device 24 and a communication interface 26 as shown in FIG. 2.

In some embodiments, the processing circuitry 22 (and/or co-processors or any other processors assisting or otherwise associated with the processing circuitry) can be in communication with the memory device 24 via a bus for passing information among components of the apparatus 20. The memory device can be non-transitory and can include, for example, one or more volatile and/or non-volatile memories. In other words, for example, the memory device may be an electronic storage device (for example, a computer readable storage medium) comprising gates configured to store data (for example, bits) that can be retrievable by a machine (for example, a computing device like the processing circuitry). The memory device can be configured to store information, data, content, applications, instructions, or the like for enabling the apparatus to carry out various functions in accordance with an example embodiment of the present disclosure. For example, the memory device can be configured to buffer input data for processing by the processing circuitry. Additionally or alternatively, the memory device can be configured to store instructions for execution by the processing circuitry.

The processing circuitry 22 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 22 can be configured to execute instructions stored in the memory device 24 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 20 of an example embodiment can also include the communication interface 26. The communication interface can be any means such as a device or circuitry embodied in either hardware or a combination of hardware and software that is configured to receive and/or transmit data from/to other electronic devices in communication with the apparatus, such as by providing for communication between a mobile device and a server and/or between a mobile device and one or more access points. The communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication.

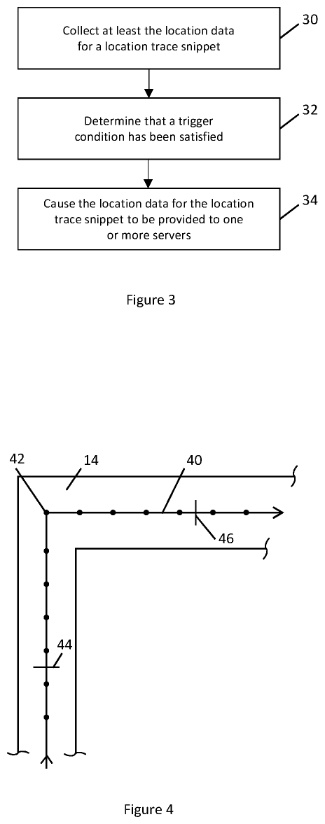

Referring now to FIG. 3, the operations performed from the perspective of a mobile device 12 are depicted. As shown in block 30 of FIG. 3, the apparatus 20 of this example embodiment includes means, such as the processing circuitry 22, the communication interface 26 or the like, for collecting at least the location data for a location trace snippet. The location trace snippet represents one or more respective locations of a mobile device within the indoor space 10 over a respective limited period of time. In this regard, the apparatus, such as the processing circuitry and/or the communication interface, may be configured to collect location data at each of one or more points in time within the limited period of time associated with the location trace snippet. At each point in time within the limited period of time, the apparatus, such as the processing circuitry and/or the communication interface, may be configured to identify the location of the mobile device and an associated time stamp defining the time at which the mobile device is positioned at the respective location.

The apparatus 20, such as the processing circuitry 22 and/or the communication interface 26, may be configured to collect the location data in various manners. For example, the apparatus, such as the processing circuitry and/or the communication interface, may be configured to receive global navigation satellite system (GNSS) signals/or cellular signals from which the location of the mobile device 12 at a respective time may be defined. Additionally or alternatively, the apparatus, such as the processing circuitry and/or the communication interface, may be configured to receive location data from any of various indoor positioning technologies that have been developed and deployed, such as indoor positioning technologies that are based on short range beacons termed pseudolites, ultrasound positioning or Wi-Fi fingerprinting techniques, positioning techniques reliant upon Zigbee or LoRa networks and/or positioning technologies that employ positioning beacons that emit Bluetooth (BT) or Bluetooth Low Energy (BTLE) signals. In accordance with at least some of these positioning technologies, such as Wi-Fi positioning techniques, the location data may include or be based upon the radio signals received by the mobile device 12 at a respective point in time. In this regard, the apparatus, such as the processing circuitry, of an example embodiment may be configured to determine the location of the mobile device based upon the radio signals that were received by reference to one or more radio maps that define the anticipated radio signals to be received at different locations throughout the indoor space.

The apparatus 20, such as the processing circuitry 22, the communication interface 26 or the like, may be configured to collect location data for a plurality of location trace snippets defining respective locations of the mobile device 12 within the indoor space 10 over different limited periods of time. For example, a first location trace snippet may be associated with time 0-10 seconds, a second location trace snippet may be associated with time 10000-10010 seconds and a third location trace snippet may be associated with time 25000-25010 seconds. Although the location trace snippets of this example have a duration of 10 seconds, the duration of the location trace snippets may vary in other example embodiments. Likewise, the spacing between location trace snippets may be longer or shorter in other example embodiments. In an example embodiment, the different limited periods of time associated with the respective location trace snippets are spaced apart and separated from one another by periods of time for which no location trace snippet is defined. As a result of collecting location data for location trace snippets that are associated only with a limited period of time and are spaced apart from one another, the privacy of the mobile device and, in turn, the user of the mobile device is enhanced by preventing a continuous path of the mobile device from being identified from the plurality of location trace snippets.

In an example embodiment, the apparatus 20, such as the processing circuitry 22, the communication interface 26 or the like, may be configured to cause the location data of the location trace snippet to be provided to one or more servers 16 for analysis on a random basis. Alternatively and as shown in block 32 of FIG. 3, the apparatus of an example embodiment may include means, such as processing circuitry or the like, for determining that a trigger condition has been satisfied. The apparatus of this example embodiment also includes means, such as the processing circuitry, the communication interface or the like, for causing the location data for the location trace snippet to be provided to one or more servers 16 in response to determining that the trigger condition has been satisfied. Based upon receipt of the location data for a location trace snippet, the one or more servers are configured to generate or modify information about one or more navigable areas of the indoor space, as described below.

A variety of different trigger conditions may be defined. For example, the trigger condition may be based on the identification of a predetermined pattern of movement of the mobile device 12 through the indoor space 10. Different patterns may be predefined to serve as the trigger condition including a turn, such as shown in FIG. 4. Another predetermined pattern is a pattern of linear movement, such as with the user walking, followed by a brief period in which no movement is detected, such as representative of a user having stopped, followed by movement again in the same linear direction, such as again indicative of a user walking in the same direction in which the user was originally walking, as may be indicative of a user approaching, opening and walking through a door or a user pausing to admire a piece of artwork or an advertisement. The different patterns of movement may be defined in various manners. For example, the apparatus 20 as embodied by a mobile device may be trained to recognize a predetermined pattern of movement by being configured to collect location data as the mobile device is moved through the respective pattern of movement. The pattern of movement represented by the location data may then be identified, such as based on user input, to represent one of the predetermined patterns of movement that will thereafter serve as a trigger condition.

In order to identify the predetermined pattern of movement, the apparatus 20 may also include or otherwise be associated with or in communication with one or more sensors, such as an accelerometer, a gyroscope, a barometer, a magnetometer, a camera or the like, configured to provide information from which the processing circuitry 22 may be configured to determine the pattern of movement of the mobile device. In this regard, the processing circuitry of an example embodiment is configured to compare the pattern of movement defined by the information provided by the one or more sensors to the predetermined pattern(s) of movement that serve as a trigger condition. In an instance in which the processing circuitry determines that the pattern of movement defined by the information provided by the one or more sensors matches the predetermined pattern of movement, the processing circuitry may be configured to indicate that the trigger condition has been satisfied. In this regard, the match between the pattern of movement defined by the information provided by the one or more sensors and the predetermined pattern of movement may be an exact match or, in an example embodiment, a substantial match in which the differences between the pattern of movement defined by the information provided by the one or more sensors to the predetermined pattern of movement is less than a predefined threshold, e.g., less than predefined percentage. Alternatively, in an instance in which the processing circuitry determines that the pattern of movement defined by the information provided by the one or more sensors does not match the predetermined pattern of movement, the processing circuitry may be configured to determine that the trigger condition has not been satisfied.

In another example embodiment, the apparatus 20, such as the processing circuitry 22, is configured to determine that the trigger condition is satisfied based on identification that the mobile device 12 has entered a room or moved between rooms. The apparatus, such as processing circuitry, may be configured to identify that the mobile device has entered a room or moved between rooms in various manners including based upon a comparison of the location data associated with the mobile device to a map of the indoor space that defines the boundaries of the various rooms. The apparatus, such as the processing circuitry, the communication interface 26 or the like, of another example embodiment is configured to determine that the trigger condition has been satisfied by an identification of a change in the characteristics of radio signals received by the mobile device. Thus, the apparatus, such as the communication interface, is configured to receive radio signals and the apparatus, such as the processing circuitry, is configured to compare the radio signals that are now received to those that were previously received in order to identify a change in the characteristics thereof.

The apparatus 20, such as the processing circuitry 22, of yet another example embodiment is configured to determine that the trigger condition had been satisfied in response to predefined schedule, such as stored by the memory device 24. In this regard, the predefined schedule defines the points in time at which a trigger condition is defined. Additionally or alternatively, the apparatus, such as the processing circuitry, the communication interface or the like, may be configured to determine that the trigger condition has been satisfied based upon a request for location data from the one or more servers 16.

In another example embodiment, the apparatus 20, such as the processing circuitry 22, is configured to determine that the trigger condition has been satisfied by or based on identification of entry of the mobile device 12 into a predefined operational state. For example, the mobile device may be determined to enter a predefined operational state in an instance in which one or more predefined applications are launched and/or executed by the mobile device, such as applications that rely upon location data. Examples of these applications include, but are not limited to, mapping applications, navigational applications, social media applications or the like.

In the foregoing examples relating to the satisfaction of a trigger condition, the limited period of time during which the location data that is collected forms a location trace snippet is based upon the time at which the trigger condition is satisfied. In an example embodiment, the apparatus 20, such as the processing circuitry 22, the communication interface 26 or the like, is configured to collect the location data for a location trace snippet for a limited period of time in response to the satisfaction of the trigger condition, that is, following the satisfaction of the trigger condition. Thus, in this example embodiment, the limited period of time associated with the location trace snippet may begin with the determination that the trigger condition has been satisfied and extend thereafter for the duration of the limited period of time. The location data that is collected following satisfaction of the trigger condition and during the limited period of time therefore forms the location trace snippet associated with the limited period of time. In other words, the trigger condition of this example embodiment establishes the starting point of the limited period of time for a respective location trace snippet.

Alternatively, the apparatus 20, such as the processing circuitry 22, the communication interface 26 or the like, may be configured to collect location data without regard to the satisfaction of the trigger condition. For example, the apparatus, such as the processing circuitry, the communication interface or the like, may be configured to collect location data on a continuous basis. In this example embodiment, the apparatus, such as the processing circuitry, is configured to determine the location data to be included in a respective location trace snippet from among the location data that has been collected, such as on a continuous basis, based upon the satisfaction of the trigger condition. In an example embodiment, the apparatus, such as the processing circuitry, may be configured to define the limited period of time associated with a respective location trace snippet such that the satisfaction of the trigger condition is a predefined point relative to the limited period of time, such as the starting point, the ending point or the midpoint of the limited period of time. In an embodiment in which the time at which the trigger condition is satisfied serves as the midpoint of the limited period of time associated with a location trace snippet, the apparatus, such as the processing circuitry, constructs the location trace snippet to include the location data that has been collected at points in time that lie within a window that is centered about the time at which the trigger condition was satisfied and that has a length equal to the limited period of time. In this example embodiment, the location trace snippet thereby includes location data both before and after the time at which the trigger condition was satisfied.

By way of example, FIG. 4 depicts an instance in which the trigger condition is defined to be the detection of a turn. The detection of a turn therefore establishes the trigger condition and defines a limited period of time for which the time at which the trigger condition was satisfied is the midpoint. Thus, location data collected both prior to and subsequent to the turn, but within the limited period of time form the associated location trace snippet. With reference to FIG. 4, the line 40 illustrates the path of travel of a user carrying the mobile device 12 with the dots along the line indicating locations at which location data was collected by the mobile device. Relative to the turn that defines the center point 42 of the limited period of time, a starting point 44 and an ending point 46 for the limited period of time are defined so as to be equally spaced from the center point defined by the turn. As shown, the location data collected at those locations represented by dots between the starting and ending points are included in the location trace snippets, while the location data collected prior to the starting point or after the ending point is not included in the location trace snippet, thereby enhancing the privacy associated with the mobile device and, in turn, the user who carries the mobile device

Thus, although FIG. 3 depicts the collection of the location data in block 30 to precede the determination of the satisfaction of a trigger condition in block 32, the determination that the trigger condition has been satisfied may have other temporal relationships to the collection of location data, such as by occurring prior to the collection of the location data or concurrent with the ongoing collection of the location data in other example embodiments.

As noted above, the limited period of time associated with a location trace snippet may be of a predefined length, e.g., 10 seconds. However, the limited predefined period of time associated with a location trace snippet of an example embodiment may extend until another trigger condition is identified. The identification of the other trigger condition then serves to end the limited period of time. The other trigger condition may be any of a variety of conditions including passage of a predefined length of time without satisfaction of one or more of the foregoing trigger conditions. Thus, a location trace snippet may commence in a manner defined by satisfaction of a trigger condition and may continue so long as the same or another trigger condition is satisfied prior to the passage of the predefined length of time. When, however, the predefined length of time passes without satisfaction of the trigger condition, the limited period of time associated with a location trace snippet concludes. Thus, in this example embodiment, the period of time associated with a location trace snippet is limited, but is not predetermined.

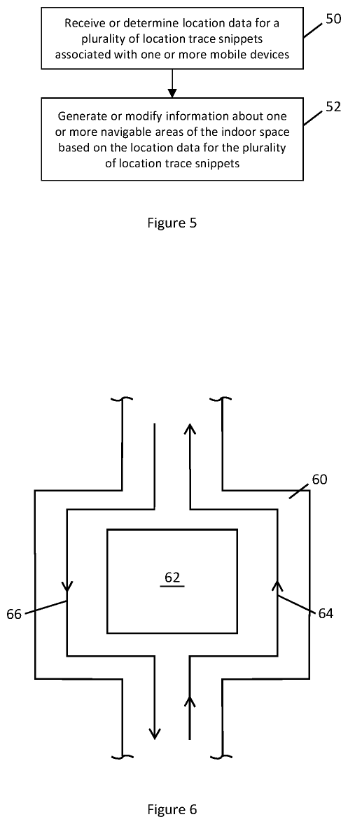

As noted above, the apparatus 20, such as the processing circuitry 22, the communication interface 26 or the like, that is embodied by a mobile device 12 is configured to cause location data of one or more location trace snippets to be provided to one or more servers 16 in response to determining that the trigger condition has been satisfied. As such, with reference now to FIG. 5, the apparatus of an example embodiment that is embodied by a server 16 includes means, such as the processing circuitry, the communication interface or the like, for receiving or determining location data for a plurality of location trace snippets associated with one or more mobile devices. See block 50. As described above, each location trace snippet of the plurality of location trace snippets respectively represents a plurality of respective locations of a respective mobile device within the indoor space 10 over a respective limited period of time.

In some example embodiments, a single mobile device 12 may provide a plurality of location trace snippets. In this example embodiment, the plurality of location trace snippets may include two or more location trace snippets associated with the respective mobile device within the indoor space 16. Each location trace snippet associated with the respective mobile device represents the plurality of respective locations of the mobile device over a different limited period of time. As described above, the different limited periods of time with which the location trace snippets are associated are not continuous, but are spaced apart from one another so as to enhance the privacy of the mobile device and, more particularly, the user of the mobile device that provides the location trace snippets. Additionally, or alternatively, location trace snippets may be provided by a plurality of mobile devices. In this regard, the plurality of location trace snippets may include one or more location trace snippets associated with a first mobile device of a plurality of mobile devices within the indoor space and one or more location trace snippets associated with a second mobile device of the plurality of mobile devices within the indoor space.

Regardless of whether the location trace snippets are provided by a single mobile device 12 or a plurality of mobile devices, the respective limited period of time associated with a location trace snippet may be defined based upon satisfaction of a trigger condition as described above. Additionally and as described above, the limited periods of time associated with the location trace snippets also serve to conserve power, bandwidth and processing resources otherwise consumed by the collection, transmission and processing of a continuous or more comprehensive stream of location data, while decreasing any privacy risks associated with the mobile device, such as the user of the mobile device, that collects and provides the location data.

A variety of different types of location data may be received or determined in block 50 of FIG. 5. In some embodiments in which the apparatus 20 embodied by the mobile device 12, such as the processing circuitry 22, determines the actual location of the mobile device at a respective point in time, the location data that is received identifies the location of the mobile device, such as in terms of positional coordinates, e.g., latitude and longitude. Alternatively, in other embodiments in which the apparatus embodied by the mobile device, such as the processing circuitry, receives radio signals from which the location of the mobile device may be determined, such as by reference to one or more radio maps, the location data that is received may include information regarding the radio signals from which the apparatus embodied by the server 16, such as the processing circuitry, is capable of determining the actual location of the mobile device at the point in time at which the radio signals were received, such as by reference to one or more radio maps.

In this regard, the location data collected by a mobile device 12 in conjunction with cellular positioning technology may include global and/or local identifiers of the cellular network cells that are observed as well as signal strength and/or pathloss estimates and/or timing measurements, such as the Timing Advance or Round-Trip Time, while the location data collected in relation to Wi-Fi or other wide-area local access networks (WLANs) may include an identifier of the access point, such as a basic service set identifier (BSSID) of the access point or a media access control (MAC) address of the air interface as well as service set identifiers (SSIDs), signal strength measurements, e.g., received signal strength index, physical Rx level and/or pathloss estimates, and/or timing measurements, e.g., Round-Trip Time. The apparatus 20 embodied by the server 16, such as the processing circuitry 22, may then be configured to determine the location of the mobile device at the point in time at which the location data was collected based upon reference to one or more radio maps, such as radio map(s) based on based upon coverage areas, node positions, radio propagation models, Rx fields, etc.

As shown in block 52, the apparatus 20 embodied by the server 16 also includes means, such as the processing circuitry 22 or the like, for generating or modifying information about one or more navigable areas of the indoor space 10 based on the location data for the plurality of location trace snippets. Based upon the information that is generated or modified regarding the navigable area(s) of the indoor space, maps may be created of the indoor space, such as may be utilized in conjunction with navigation or mapping applications, social media applications or the like. By collecting a plurality of location trace snippets, a map of the indoor space may be created or updated that is more accurate and complete, thereby leading to an improved user experience in relation to applications that rely upon the map of the indoor space.

Various types of information regarding navigable area(s) of the indoor space 10 may be generated or modified. In an example embodiment, the apparatus 20 embodied by the server 16, such as the processing circuitry 22, is configured to determine the location of an object within the indoor space based upon the location trace snippets. In this regard, in an instance in which the location trace snippets consistently indicate that the paths of travel of mobile devices change direction so as to move around a particular region within the indoor space, the apparatus, such as the processing circuitry, may be configured to determine that an object is located within the indoor space in the particular region that is avoided by the location trace snippets. With respect to FIG. 6, for example, the location trace snippets may indicate that the paths of travel of mobile devices that enter a room 60 change in direction so as to avoid a central region 62 of the room, thereby indicating that an object, such as a table, a statue or other piece of artwork or the like, may be located within the region that is avoided by the mobile devices.

Additionally, or alternatively, the apparatus 20 embodied by the server 16, such as the processing circuitry 22, of an example embodiment is configured to generate or modify information about navigable area(s) of the indoor space 10 by determining a path through or area within the indoor space based upon the location trace snippets. For example, the location trace snippets depicted in FIGS. 4 and 6 indicate paths of travel through the indoor space such that the apparatus, such as the processing circuitry, is capable of determining a path through an area within the indoor space to include that path traveled by the mobile devices that have constructed the location trace snippets.

In another example embodiment, the apparatus 20 embodied by the server 16, such as the processing circuitry 22, is configured to generate or modify information about one or more navigable areas of the indoor space 10 by determining a direction of travel through at least a portion of the indoor space based upon the location trace snippets. In this regard, the location data from which the location trace snippets are constructed permit the direction of travel of the mobile device 12 to be determined during the limited period of time. In an instance in which the apparatus, such as the processing circuitry, determines that the location trace snippets within a certain navigable area of the indoor space consistently or uniformly represent travel in the same direction, the apparatus, such as the processing circuitry, may be configured to determine that the navigable area has a predefined direction of travel in that same direction. Referring again to FIG. 6, the location trace snippets may consistently demonstrate that a first direction of travel 64 in a first direction is established to the right of the object 62 in the center of the room 60 and a different direction of travel 66 in a second direction, opposite the first direction, is established on the left side of the object in the center of the room.

In yet another example embodiment, the apparatus 20 embodied by the server 16, such as the processing circuitry 22, is configured to generate or modify information about one or more navigable areas of the indoor space 10 by determining a boundary or shape of the indoor space based upon the location trace snippets. In this regard, the apparatus, such as the processing circuitry, is configured to evaluate one or more location trace snippets and determine the bounds of the navigable area through which the location trace snippets extend. As such, the apparatus, such as the processing circuitry, may be configured to determine the boundary and/or shape of the navigable area to be defined by the outline of the collection of location trace snippets that extend through the respective navigable area.

Other examples of information about navigable area(s) of the indoor space 10 that may be generated or modified include information from which occupancy of the indoor space may be detected, such as for smart building applications, and/or information regarding the number of people in a particular region of the indoor space, which may be useful for locating and/or pricing advertisement(s) and/or informing load balancing activities that serve to encourage or discourage people from passing through different portions of the indoor space. The information about navigable area(s) of the indoor space that may be generated or modified may additionally or alternatively include information regarding modifications to or reconfiguration of a portion of the indoor space, such as in instances in which the location trace snippets evidence that users now move through a space that was previously restricted and/or that users no longer move through a space that previously served as a walkway. In another example embodiment, the information about navigable area(s) of the indoor space that may be generated or modified may include information that indicates that one or more components that support the indoor positioning technology, such as one or more access points, are potentially no longer performing properly, such as in instances in which the location trace snippet indicates that the mobile device 12 is located in a region that is nonsensical or impossible relative to the map of the indoor space, thereby permitting maintenance procedures to be commenced in a timely manner.

As described above, FIGS. 3 and 5 are flowcharts of an apparatus 20, method, and computer program product configured to enable selective positioning requests according to an example embodiment. It will be understood that each block of the flowcharts, and combinations of blocks in the flowcharts, may be implemented by various means, such as hardware, firmware, processing circuitry 22, and/or other devices associated with execution of software including one or more computer program instructions. For example, one or more of the procedures described above may be embodied by computer program instructions. In this regard, the computer program instructions which embody the procedures described above may be stored by the memory device 24 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for generating or modifying information about one or more navigable areas of an indoor space, the method comprising:
receiving or determining, by processing circuitry, location data for a plurality of location trace snippets associated with one or more mobile devices, each location trace snippet of the plurality of location trace snippets respectively represent a plurality of respective locations of a respective mobile device within the indoor space over a respective limited period of time; and
based on the location data for the plurality of location trace snippets, generating or modifying, by the processing circuitry, information about one or more navigable areas of the indoor space.

2. A method according to claim 1, wherein the plurality of location trace snippets comprise two or more location trace snippets associated with the respective mobile device within the indoor space with each location trace snippet associated with the respective mobile device representing the plurality of respective locations of the respective mobile device over a different limited period of time.

3. A method according to claim 1, wherein the plurality of location trace snippets comprise one or more location trace snippets associated with a first mobile device of the one or more mobile devices within the indoor space and one or more location trace snippets associated with a second mobile device of the one or more mobile devices within the indoor space.

4. A method according to claim 1, wherein the respective limited period of time associated with a location trace snippet is defined based upon satisfaction of a trigger condition.

5. A method according to claim 1, wherein generating or modifying information about one or more navigable areas of the indoor space comprises determining a location of an object within the indoor space based upon the location trace snippet.

6. A method according to claim 1, wherein generating or modifying information about one or more navigable areas of the indoor space comprises determining a path through or area within the indoor space based upon the location trace snippet.

7. A method according to claim 1, wherein generating or modifying information about one or more navigable areas of the indoor space comprises determining a direction of travel through at least a portion of the indoor space based upon the location trace snippet.

8. A method according to claim 1, wherein generating or modifying information about one or more navigable areas of the indoor space comprises determining a boundary or shape of the indoor space based upon the location trace snippet.

9. An apparatus configured to generate or modify information about one or more navigable areas of an indoor space, the apparatus comprising processing circuitry and at least one memory including computer program code instructions, the computer program code instructions configured to, when executed by the processing circuity, cause the apparatus to:
receive or determine location data for a plurality of location trace snippets associated with one or more mobile devices, each location trace snippet of the plurality of location trace snippets respectively represent a plurality of respective locations of a respective mobile device within the indoor space over a respective limited period of time; and
based on the location data for the plurality of location trace snippets, generate or modify information about one or more navigable areas of the indoor space.

10. An apparatus according to claim 9, wherein the computer program code instructions configured to generate or modify information about one or more navigable areas of the indoor space comprise computer program code instructions configured to determine a location of an object within the indoor space based upon the location trace snippet.

11. An apparatus according to claim 9, wherein the computer program code instructions configured to generate or modify information about one or more navigable areas of the indoor space comprise computer program code instructions configured to determine a path through or area within the indoor space based upon the location trace snippet.

12. An apparatus according to claim 9, wherein the computer program code instructions configured to generate or modify information about one or more navigable areas of the indoor space comprise computer program code instructions configured to determine a direction of travel through at least a portion of the indoor space based upon the location trace snippet.

13. An apparatus according to claim 9, wherein the computer program code instructions configured to generate or modify information about one or more navigable areas of the indoor space comprise computer program code instructions configured to determine a boundary or shape of the indoor space based upon the location trace snippet.

14. A method for providing location data for a location trace snippet associated with a mobile device, the method comprising:
collecting at least the location data for the location trace snippet, the location trace snippet representing one or more respective locations of the mobile device within an indoor space over a respective limited period of time;
determining, by processing circuitry, that a trigger condition has been satisfied; and
in response to determining that the trigger condition has been satisfied, causing the location data for the location trace snippet to be provided to one or more servers, thereby enabling the one or more servers to generate or modify information about one or more navigable areas of the indoor space.

15. A method according to claim 14, wherein collecting the location data comprises commencing collection of the location data for the limited period of time in response to determining that the trigger condition has been satisfied.

16. A method according to claim 14, wherein collecting the location data comprises collecting the location data without regard to the satisfaction of the trigger condition, and wherein the method further comprises determining the location data for the location trace snippet from among the location data that has been collected based upon the satisfaction of the trigger condition.

17. A method according to claim 14, wherein the limited period of time is based upon a time at which the trigger condition was satisfied.

18. A method according to claim 14, wherein determining that the trigger condition has been satisfied comprises or is based on one or more of: (i) identification of a predefined pattern of movement of the mobile device through the indoor space, (ii) identification that the mobile device has entered a room or moved between rooms, (iii) identification of a change in characteristics of radio signals received by the mobile device, (iv) a predefined schedule or (v) a request from the one or more servers.

19. A method according to claim 18, wherein the predefined pattern of movement comprises a turn.

20. A method according to claim 14, wherein determining that the trigger condition has been satisfied comprises or is based on identifying entry of the mobile device into a predefined operational state.
